(19) United States
(12) Patent Application Publication
(10) Pub. No.: US 2017/0140551 A1
(43) Pub. Date: May 18, 2017

(54) METHOD FOR SEGMENTING AND PREDICTING TISSUE REGIONS IN PATIENTS WITH ACUTE CEREBRAL ISCHEMIA

(71) Applicant: UNIVERSITÄT BERN, bern (CH)

(72) Inventors: Stefan Bauer, Bern (CH); Mauricio Reyes, Wabern (CH); Roland Wiest, Säriswil (CH)

(21) Appl. No.: 15/323,339

(22) PCT Filed: Jun. 29, 2015
(86) PCT No.: PCT/IB2015/054872

§ 371 Date: Dec. 30, 2016

(30) Foreign Application Priority Data
Jun. 30, 2014 (EP) 14174885.5

(51) Int. Cl. G06T 7/62; G06K 9/66; G06T 7/174; G06K 9/62; G06T 7/00; G06T 7/11

(52) U.S. Cl. CPC G06T 7/62; G06T 7/0012; G06T 7/11; G06T 7/174; G06K 9/6256; G06K 9/66; G06K 9/6267; G06T 2207/20081; G06T 2207/10088; G06T 2207/30016; G06T 2207/10081; G06T 2207/30096

(57) ABSTRACT

A segmentation/prediction method is described for differentiating between infarct, penumbra and healthy regions in a tomographic (e.g. MRI or CT) image dataset of the brain of a stroke patient under examination. The method comprises deriving (7, 11) a multidimensional set of feature vectors from a plurality of baseline modalities, where the modalities comprising both structural and functional modalities. For each volume element of image dataset, an n-dimensional feature vector is extracted (8, 12), such that it represents both structural and functional modalities of the volume element. A classification (13) is performed on the volume element and the classification is used to inform the segmentation (14) in order to label the volume element as belonging to healthy tissue, penumbra tissue, or infarct tissue. The classification operation (13) uses a learning-based classifier, trained using pre-treatment image datasets comprising a plurality of second hypoxic regions, the second hypoxic regions being of the brains of previous stroke patients. In a second embodiment, follow-up (post-treatment) image datasets are used for training the classifier.

### TECHNICAL FIELD OF THE INVENTION

The present invention relates to the field of multi-dimensional imaging and, in particular, to the field of classifying volumetric elements of affected regions of the brains of acute ischemic stroke patients in order to differentiate between salvageable and non-salvageable brain tissue.

### BACKGROUND OF THE INVENTION

Acute ischemic stroke, or cerebral ischemia, is a neurological emergency which may be reversible if treated rapidly. Outcomes for stroke patients are strongly influenced by the speed and accuracy with which the ischemia can be identified and treated. Effective reperfusion and revascularization therapies are available for salvaging regions of brain tissue which are characterized by reversible hypoxia, and these regions must be identified and distinguished from tissue which is destined to infarct. Volumetric imaging of the brain tissue, using computer tomography (CT) or magnetic resonance imaging (MRI) may be used to generate 4D (spatial and temporal) scans of the brain tissue of the patient. Skilled clinical practitioners, aided by image analysis software, can read such image sequences to assess the likely extent of the eventual infarct region. Image analysis and treatment decision may be performed visually by a neuroradiologist or a stroke neurologist. The ratio, or mismatch, between the infarct volume and the penumbra volume may be taken as an indicator of the likely effectiveness of reperfusion therapy. The larger the mismatch, the more likely the patient is to have a favorable prognosis. In order to provide an accurate measure of this ratio, it is important to achieve a fast and accurate classification of volumetric elements into those which will infarct, those which belong to the penumbra, and those which comprise healthy tissue. This analysis may be performed on CT image sets or MRI image sets, in which the infarct core can be identified by diffusion-weighted imaging (DWI), and the hypo-perfused, yet vital, potentially salvageable tissue adjacent to the infarct core can be identified using perfusion-weighted imaging (PWI). This segregation technique may be referred to as diffusion-perfusion mismatch analysis. DWI and PWI are well-known abstraction techniques and will not be described here.

### PRIOR ART

It has been considered to use computer-assisted image analysis to quantify the mismatch mentioned above. However, previous proposals have usually focused on the segmentation of the infarct only, or on the hypo-perfused region only. Approaches have been proposed which consider both regions simultaneously, but these have used relatively simplistic classification models and have limited accuracy.

In M. Straka et al, “Real-Time Diffusion-Perfusion Mismatch Analysis in Acute Stroke”, Journal of Magnetic Resonance Imaging, JMRI, vol 32, no. 5, pages 1024-1037, November 2010, an automated image analysis tool was described for identifying candidates for acute stroke treatment. This approach relies on DWI and PWI to quantify the mismatch. For identification of the ischemic (infarct) core, the Apparent Diffusion Coefficient (ADC), a quantitative measure derived from diffusion images, is thresholded by taking diffusion rates of less than 600×10⁻⁶ mm²/s. To identify the penumbra region, the Tmax map derived from dynamic susceptibility contrast (DSC) perfusion images is thresholded by taking perfusion times greater than 6 seconds. Some additional morphological constraints are applied, to suppress outliers. While this technique appears promising, its mismatch analysis performance stands to be improved.

An automated segmentation method using multiple MRI modalities has been proposed for MRI analysis of brain tumors. S. Bauer et al, “Fully automatic segmentation of brain tumor images using support vector machine classification in combination with hierarchical conditional random field regularization”, International Conference on Medical Image Computing and Computer-Assisted Intervention, vol. 14, no. Pt 3. January 2011, pp. 354-61, proposed a method for delineating brain tumors using multiple structural modalities.

A tissue outcome prediction method was proposed in US patent application US2007/0167727, using a combination of diffusion weighted images (DWI) and perfusion weighted images (PWI).

The prior art methods have the disadvantage that their outputs are not sufficiently reliable or accurate to enable confident use of the methods in automated tissue classification, outcome prediction or assessment for therapy.

### BRIEF DESCRIPTION OF THE INVENTION

The present invention aims to overcome the above and other shortcomings inherent in the prior art. In particular, the invention aims to provide a method as set out in claim 1. Further variants of the inventive method are set out in the dependent claims.

The invention and its advantages will further be explained in the following detailed description, together with illustrations of example embodiments and implementations given in the accompanying drawings, in which:

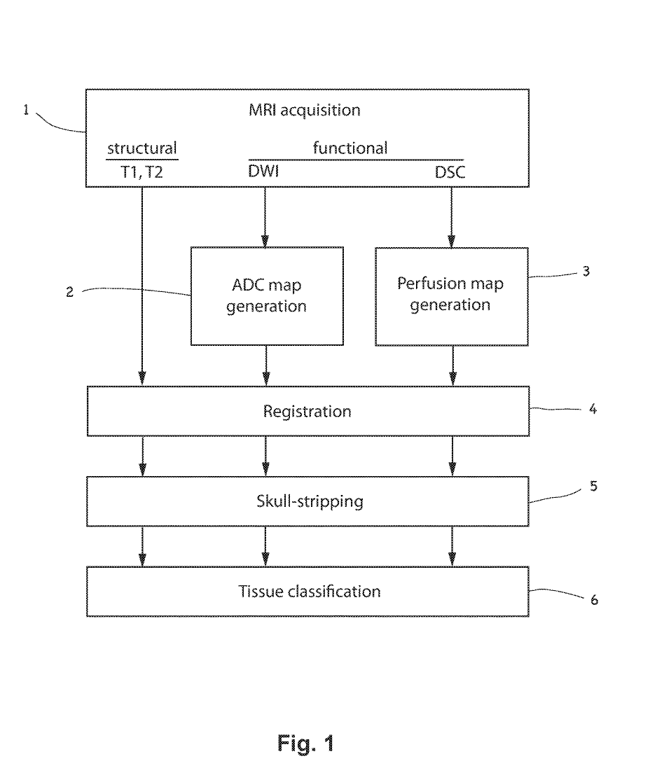

FIG. 1 shows a simplified flow diagram of an example segmentation method for use in a segmentation/prediction method according to the invention.

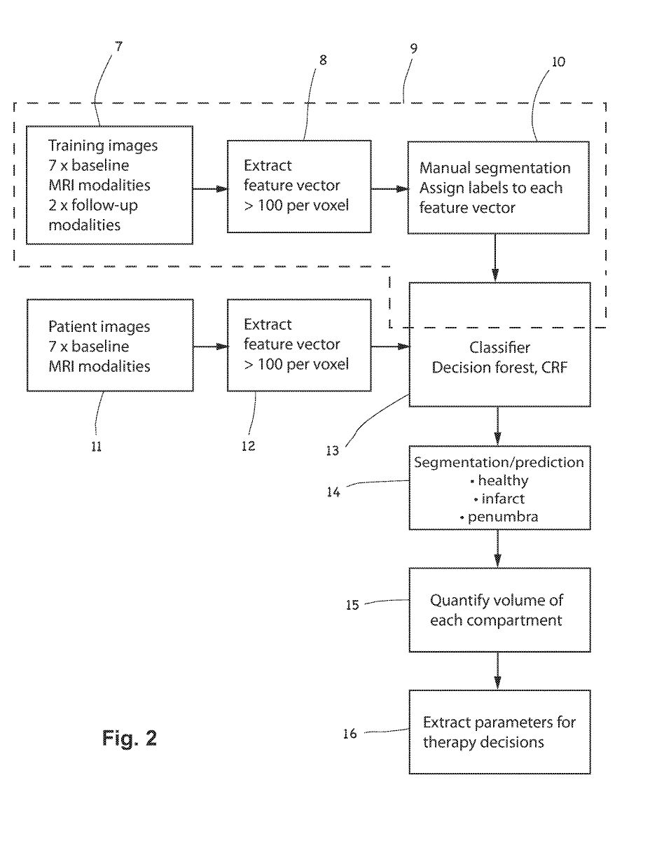

FIG. 2 shows a simplified flow diagram of an example segmentation/prediction method according to the invention.

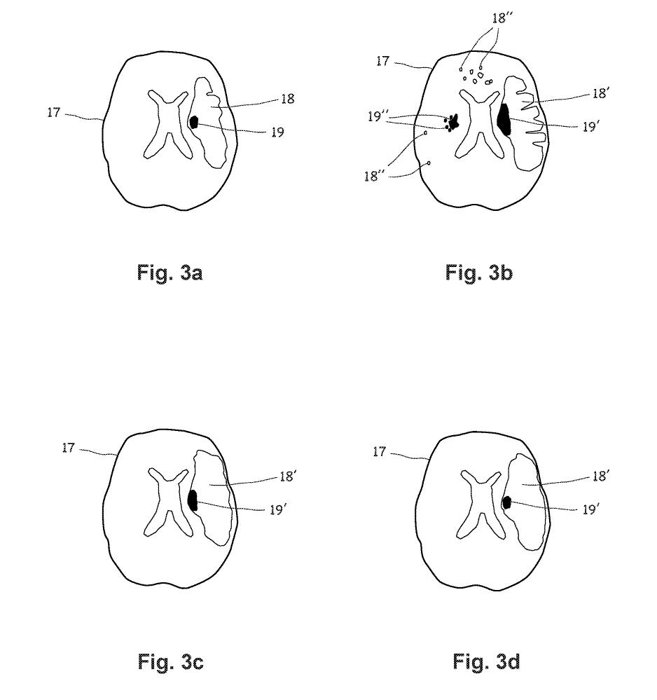

FIG. 3a shows, in greatly simplified, schematic form, an example of an MRI image of an axial brain section of a stroke patient.

FIG. 3b shows an MRI segmentation generated, using a prior art segmentation method, for the patient whose brain is depicted in FIG. 3a.

FIG. 3c shows an MRI segmentation generated for the patient whose brain is depicted in FIG. 3a, using a segmentation/prediction method according to a first embodiment of the invention.

FIG. 3d shows an MRI segmentation generated for the patient whose brain is depicted in FIG. 3a, using a segmentation/prediction method according to a second embodiment of the invention.

### DETAILED DESCRIPTION OF THE INVENTION

The invention will now be described in detail with reference to the drawings. Note that the drawings are intended merely as illustrations of example embodiments of the invention, and are not to be construed as limiting the scope of the invention. Where the same reference numerals are used in different drawings, these reference numerals are intended to refer to the same or corresponding features. However, the use of different reference numerals should not necessarily be taken as an indication that the referenced features are dissimilar.

The examples and discussion below are described with reference to the application of the method of the invention to the use of MRI imaging. However, it should be understood that the principles of the invention may also be applied in other tomographic or volumetric imaging regimes such as CT imaging.

Similarly, the invention has been described in relation to segmenting or labeling volume elements into infarct, penumbra and healthy tissue. However, the segmentation or prediction may be used to identify tissue types other than these three. A greater number of tissue-types (labels) may be identified, for example, than the three mentioned.

Stroke MRI protocols include a wealth of information which includes structural information such as non-enhanced and enhanced T1-weighted, T2-weighted, fluid attenuated inversion recovery (FLAIR), and functional information such as PWI and DWI image datasets and vessel imaging (magnetic resonance angiography, MRA). By combining structural and functional information, and by employing modern machine learning concepts, the method of the present invention provides a segmentation and prediction of volumetric elements which offers a significant improvement over prior art methods of identifying infarct core and penumbra tissue. A supervised classification approach is used for performing a multi-parametric segmentation from a plurality of different MRI modalities. The classification may be trained using manually-labeled samples.

An overview example of a method according to the invention will now be described with reference to FIG. 1. The segmentation is based on structural and functional magnetic resonance (MR) images, however it should be understood that the principles underlying the invention may also be implemented using other types of tomographic images. In the illustrated example, T1-weighted images with contrast enhancement (referred to as the T1contrast modality), T2-weighted images, diffusion-weighted images (DWI) and dynamic susceptibility contrast (DSC) perfusion-weighted images (PWI) may be acquired from acute ischemic stroke patients before and after treatment. This image acquisition step is indicated by reference number 1 in FIG. 1.

Apparent diffusion coefficient (ADC) maps are extracted from the diffusion-weighted images, as indicated by reference 2. Standard perfusion maps (of which there may be four, for example, representing four different modalities) may be computed from the DSC perfusion-weighted images, as indicated by reference 3, using known techniques. The perfusion maps may for example comprise cerebral blood flow (CBF), cerebral blood volume (CBV), mean transit time (MTT) and the peak time (Tmax) modalities. All seven modalities (T1contrast, T2, ADC, CBF, CBV, MTT, Tmax) from before and after treatment may then be rigidly registered, for example to the pre-treatment T1contrast image of the patient, as indicated by reference 4. A skull-stripping step 5 may be automatically performed which, as will be seen, may improve the quality of the tissue classification 6. Skull-stripping involves detecting and removing the skull regions from the images. The skull regions may give rise to unwanted outliers and false positives in the classification process.

In the illustrated overview example, the seven pre-treatment MRI modalities (T1contrast, T2, ADC, CBF, CBV, MTT, Tmax) are used as an input for a segmentation/prediction algorithm which will be described in relation to FIG. 2. The proposed segmentation/prediction method used in this example may employ a classification method adapted from the method proposed for brain tumors in the article by S. Bauer et al, mentioned earlier. The segmentation task may for example be cast as an energy minimization problem in a conditional random field context (CRF), with the energy to be minimized being expressed as

$$E = {\sum }_{i} V ( {y}_{i} , {x}_{i} ) + {\sum }_{ij} W ( {y}_{i} , {y}_{j} , {x}_{i} {x}_{j} ) \qquad EQ1$$

where the first term in equation EQ1 corresponds to the voxel-wise singleton potentials, and the second term corresponds to the pairwise potentials, modeling voxel-to-voxel interactions. x is a voxel-wise feature vector and y is the final segmentation label. The singleton potentials may be computed by a decision forest classifier, as indicated by reference 13 in FIG. 2. A decision forest is a supervised classifier that makes use of training data for computing a probabilistic output label for every voxel based on a certain feature vector. By way of example, a 283-dimensional feature vector x may be extracted (8 and 12 in FIG. 2) and used as an input for the classifier 13, comprising the voxel-wise intensities and multi-scale local texture, gradient, symmetry and position descriptors of each modality. These singleton potentials are computed according to equation (EQ2), with p(\tilde{y}ᵢ|xᵢ) being the output probability from the classifier and 6 is the Kronecker-δ function.

V(yᵢ,xᵢ)=p(\tilde{y}ᵢ|xᵢ)·(1−δ(\tilde{y}ᵢ,yᵢ)) EQ2

The second term in equation EQ1 corresponds to the pairwise potentials, introducing a spatial regularization in order to suppress noisy outputs caused by outliers. It is computed according to equation EQ3, where wₛ(i, j) is a weighting function that depends on the voxel spacing of the image in each dimension. The term (1−δ(yᵢ,yᵢ)) penalizes different labels of neighboring voxels, and the degree of neighborhood smoothing is regulated by the difference of the feature vectors in the

$$term exp ( \frac{\vert {x}_{i} - {x}_{j} \vert}{2 \cdot x} ) \cdot W ( {y}_{i} , {y}_{j} , {x}_{i} , {x}_{j} ) = {w}_{s} ( i , j ) \cdot ( 1 - δ ( {y}_{i} , {y}_{j} ) ) \cdot exp ( \frac{\vert {x}_{i} - {x}_{j} \vert}{2 \cdot x} ) \qquad EQ3$$

Optimization of the energy function in equation EQ1 may be achieved using known optimization strategies.

As described above, a multi-dimensional feature vector is derived for each volume element, and may for example comprise more than 100 features. The example of a 283-dimensional feature vector has been mentioned above, however it has been found that a number of features greater than 50, or preferably greater than 100, or more preferably greater than 200 may achieve the advantageous effects of the invention. In the particular example case, the 283 features concerned may for example be made up as follows from the combination of seven image modalities (T1contrast, T2, ADC, CBF, CBV, MTT, Tmax):
Voxel-wise multi-modal intensities—1 feature per modality (normalized voxel intensity values):

T2 intensity

T1contrast intensity

ADC intensity

CBF intensity

CBV intensity

MTT intensity

Tmax intensity
Textures from patches in 3×3×3 neighborhood—15 features per modality (values computed based on intensities from local patches: Mean, Variance, Skewness, Kurtosis, Energy, Entropy, Min, Max, Percentile10, Percentile25, Percentile50, Percentile75, Percentile90, Range, SNR):

T2 texture3

T1contrast texture3

ADC texture3

CBF texture3

CBV texture3

MTT texture3

Tmax texture3
Textures from patches in 5×5×5 neighborhood—15 features per modality (values computed based on intensities from local patches: Mean, Variance, Skewness, Kurtosis, Energy, Entropy, Min, Max, Percentile10, Percentile25, Percentile50, Percentile75, Percentile90, Range, SNR):

T2 texture5

T1contrast texture5

ADC texture5

CBF texture5

CBV texture5

MTT texture5

Tmax texture5
Gradient statistics from patches in 3×3×3 neighborhood—3 features per modality (values computed based on gradient magnitude from local patches: gradMagCenter, gradMagMean, gradMagVariance):

T2 grad3

T1contrast grad3

ADC texture grad3

CBF texture grad3

CBV grad3

MTT grad3

Tmax grad3
Gradient statistics from patches in 5×5×5 neighborhood—3 features per modality (values computed based on gradient magnitude from local patches: gradMagCenter, gradMagMean, gradMagVariance):

T2 grad5

T1contrast grads

ADC texture grad5

CBF texture grad5

CBV grad5

MTT grad5

Tmax grad5
Location features—3 features (values computed from smoothed or approximated coordinates of registered atlas image in three spatial dimensions):

Smoothed or approximated coordinates in standard atlas
Multi-scale symmetry features—3 features per modality (values computed from intensity difference across midsagittal symmetry plane: intensityDiff approximatedScale1, intensityDiff approximatedScale2, intensityDiff approximatedScale3):

T2 sym

T1contrast sym

ADC sym

CBF sym

CBV sym

MTT sym

Tmax sym

While the above example relates to the application of the invention to MRI image datasets, it should be noted that a similar approach can be used with other types of volumetric or tomographic imaging, such as CT imaging. In the case of CT imaging, the method may for example be performed with a smaller number of modalities, for example the four perfusion (functional) modalities and the structural CT modality, and with a smaller number (e.g. around 200) of features than the e.g. 283 features mentioned for the feature vector in the MRI implementation.

When using MRI images, the infarct regions may advantageously be defined with reference to the DWI or T2 image, whereas with CT images, the infarct region may be defined with reference to one of the perfusion maps, such as the CBV modality, for the training datasets.

A schematic representation of an example method according to the invention is illustrated in FIG. 2. In the illustrated method, two data acquisition branches are shown. The first branch, indicated by dotted line 9, comprises the steps 7, 8 and 10 of acquiring training datasets, which are performed “off-line”, i.e. in one or more pre-processing sequences, before the method is used in the an examination of a patient. The second branch comprises the steps 11, 12 performed in acquiring and processing MRI datasets of the patient.

As will be described in relation to the first embodiment of the invention, the training data may comprise image datasets, 7, whose modalities and feature vectors, 8, correspond to the image dataset(s), 11, and feature vector(s), 12, of patients. The training data comprises pre-treatment images comprising hypoxic regions of previous stroke patients, and the voxels may be manually segmented, 10, for example by an experienced neuroradiologist, in order to generate training data for training the classifier, 13.

As will described in relation to the second embodiment of the invention, and as illustrated in FIG. 2, the training data 7 may additionally comprise follow-up image datasets, for example post-treatment image datasets corresponding to (i.e. relating to the same patients as) at least some of the pre-treatment MRI images of the hypoxic regions of the previous stroke patients mentioned above. In the example illustrated in FIG. 2, the follow-up MRI image datasets may comprise only structural modalities (e.g. T1contrast and T2) This allows the learning process to benefit from the outcome information present in the structural modality information. Advantageously, the training data 7 may optionally include information about the treatment which was carried out on the patients whose follow-up MRI image data is included. Such treatment parameter information (for example the type of treatment, or the frequency, dosage, drug details, therapy duration, surgical interventions etc) may also be included in the training of the classifier in order to improve the quality of the prediction in step 14 and the parameters for taking therapy decisions in step 16. The latter parameters may, for example, include a proposal for therapy parameters which may offer the patient under examination the best or the least-worst outcomes.

Two example embodiments of the invention are described below. The embodiments differ principally in the training sets used. According to a first embodiment of the present invention, segmentation is based on manual segmentations of infarct core and penumbra on the pre-treatment images of patients (i.e. without taking into account MRI datasets from follow-up scans). According to a second embodiment of the invention, the method aims for prediction instead of (or in addition to) segmentation. As in the first embodiment, the training may be based on manual segmentation, but in this case only the penumbra is defined on the pre-treatment images, whereas the infarct core is the real infarct, which is defined on real follow-up datasets (for example the T2-weighted images from a follow-up examination several weeks or months after the stroke incident). The follow-up images are only needed for generating the training data; once the classifier 13 has already been trained, only the pre-treatment images are needed when assessing new patients. According to a variant of the second embodiment, separate classifiers 13 may be trained for best- and/or worst-case prediction of the extent of infarction, dependent on the outcome of a procedure for limiting tissue damage (such as mechanical thrombectomy). Thus, a first classifier 13 (for predicting a favorable outcome) may be trained using the datasets of patients who responded well to treatment, and/or a second classifier 13 (for predicting an unfavorable outcome) may be trained using the datasets of patients who responded poorly to treatment, or who did receive treatment. As mentioned above, the follow-up images are only needed for generating the training data, so that the approach can be used for decision-making before treatment of new patients. If both the best-case and worst-case classifiers are provided, then a surgeon, faced with the decision of whether or not to proceed with a particular treatment, can weigh the best-case prediction of the first classifier (which represents a prediction of a best-case outcome following the proposed treatment) against the worst-case prediction of the second classifier (representing for example the outcome prediction if the treatment is not performed). Alternatively, if only the second (worst-case) classifier is provided, then the surgeon may use the worst-case prediction of the second classifier to assess the predicted worst-case outcome against an expected treatment outcome based on his or her own experience. By training the classifiers using data-sets limited to worst-case (or best-case), the quality of the classifier prediction performance can be significantly enhanced. The best-case and/or worst-case datasets (and hence their corresponding classifiers) may advantageously be limited to those obtained following one particular treatment procedure (such as the mechanical thrombectomy mentioned above). Further best- and/or worst case datasets may be used to provide best and/or worst-case classifiers for other treatments (e.g. thrombolysis, endartorectomy or angioplasty). For some treatment procedures (e.g. thrombolysis), a worst-case classifier may be trained to predict a harm outcome (i.e. an unfavorable outcome such as a hemorrhage which results from carrying out the procedure, and which is worse than not carrying out the procedure). Note that the above terms worst-case and best-case may be defined in terms of the extent and/or the location of the revascularization, rather than in terms of the effect on the patient's wellbeing.

FIGS. 3a to 3d show in highly schematic form four axial slices which illustrate how the method according to the invention can achieve significant improvements over prior art segmentation/prediction methods. FIG. 3a shows a groundtruth image representing a true segmentation between infarct region 10 and penumbra region 18 in a patient's brain 17. Such a groundtruth image may be arrived at, for example, by manual segmentation by an expert.

FIG. 3b illustrates the same axial slice, on which segmentation has been performed by a prior art method, such as the method described in Straka et al, using a DWI/PWI mismatch method. As can be seen in FIG. 3b, the penumbra 18′ identified by this method is a similar shape to the groundtruth penumbra, but has a significantly smaller volume. Some false-positive outliers 18″ are also identified by this method, which may be due to the use of a simple thresholding procedure. By contrast, the infarct region 19′ was identified as being much larger than its true size in this method. Significant outliers were also identified, also as a result of a naïve thresholding procedure. Taken together, these segmentation errors may aggregate to produce a very significant error in the volumes, and thus the diffusion/perfusion mismatch (ratio). In the illustrated case, for example, the patent will be classified as having a much smaller mismatch than is the case in reality, and thus will be incorrectly assessed as unsuitable for reperfusion or revascularization therapy.

FIG. 3c shows the same axial slice from the same patient, on which segmentation has been performed using a method according to the first embodiment of the present invention. In this case, it can be seen that the use of a classifier, trained using pre-treatment images of other patients, has significantly improved the segmentation when compared with the prior art, thresholded method whose results are shown in FIG. 3b. The use of manifold (e.g. >50, or preferably >100, or more preferably >200) feature vectors for the training and classification results in greatly improved segmentation accuracy. By running the classifier training offline, the active operation of the classifier can also be made significantly faster.

FIG. 3d shows the same axial slice from the same patient, on which segmentation has been performed using a method according to the second embodiment of the present invention. The relative volumes of the infarct 18′ and the penumbra 19′ are significantly more similar to those of the groundtruth image than those produced by either the prior art method or the first embodiment. In particular, the prediction approach of the second embodiment, by taking into account real follow-up training datasets, performs better at predicting the real infarct core.

The methods of the first and second embodiment also perform significantly better than prior art methods in patients who have no infarct core at the follow-up examination. However, both the prior art and the first embodiment are more prone to detect false positive infarct regions. Also here, the predictive approach of the second embodiment seems to do a better job because only penumbra (no infarct region) is detected. Integrating all the information that is available within routine MRI datasets offers advantages for treatment selection in individual patients. Experimental clinical observations suggest that the inventive method provides significantly and consistently better segmentation, and thereby better patient assessment, than prior art methods. For further improvements in accurate prediction, the method may include clinically meaningful information such as the stroke topography, severity, the vascular supply of the hypo-perfused tissue and other prognostic factors as modeling parameters.

1. Segmentation and/or prediction method for, in a first tomographic image dataset (11) of the brain of a stroke patient under examination, differentiating volume elements of a first hypoxic region (18, 18′, 19, 19′) from those of a healthy region of the brain, the method being characterized by the steps of:
deriving (11) a first plurality of tomographic imaging modalities from the first image dataset, the first plurality of modalities comprising both structural and functional modalities,
for each of the volume elements, extracting (12) an n-dimensional feature vector from the structural and functional modalities of the volume element, for each of the volume elements, performing a classification operation (6, 13) on the volume element, the classification operation (6, 13) comprising a learning-based classifier (13) trained using a plurality of second tomographic image datasets (7) of the brains of previously-examined stroke patients, the second image datasets (7) comprising a plurality of second hypoxic regions.

2. Segmentation and/or prediction method according to claim 1, in which the first hypoxic region comprises an infarct region (19, 19′) and a penumbra (18, 18′) region, and wherein the method comprises differentiating volume elements of the infarct region (19, 19′) from those of the penumbra (18, 18′) region.

3. Segmentation and/or prediction method according to claim 1 or claim 2, wherein the second image datasets (7) comprise pre-treatment tomographic image datasets of the brains of the previously-examined stroke patients.

4. Segmentation and/or prediction method according to one of claims 1 to 3, in which the learning-based classifier (13) is trained using a plurality of third tomographic image datasets of the second hypoxic regions, wherein the third image datasets comprise follow-up or post-treatment image datasets of the brains of the previously-examined stroke patients.

5. Segmentation and/or prediction method according to claim 4, wherein the third image datasets comprise fewer modalities than the second image datasets.

6. Segmentation and/or prediction method according to claim 5, wherein the third image datasets comprise substantially only structural modalities.

7. Segmentation and/or prediction method according to one of claims 4 to 6, in which:
the post-treatment datasets comprise one or more parameters of one or more treatments which resulted in the post-treatment datasets, and the learning-based classifier is further trained using the said parameters.

8. Segmentation and/or prediction method according to one of the preceding claims, in which n is greater than 50, or n is greater than 100, or n is greater than 200.

9. Segmentation and/or prediction method according to one of the preceding claims, in which the first image dataset comprises MRI images, in which case the first plurality of modalities comprises at least seven modalities, or CT images, in which case the first plurality of modalities comprises at least five modalities.

10. Segmentation and/or prediction method according to claim 9, in which the at least seven modalities or at the least five modalities comprise at least one structural modality.

11. Segmentation and/or prediction method according to one of the preceding claims, in which the first plurality of modalities comprises at least one diffusion-weighted (DWI) image.

12. Segmentation and/or prediction method according to one of the preceding claims, in which the first plurality of modalities comprises at least four perfusion image modalities.

13. Segmentation and/or prediction method according to claim 12, in which the at least four modalities comprise at least CBF, CBV, MTT and Tmax modalities.

14. Segmentation and/or prediction method according to one of the preceding claims, in which the functional modality or modalities of the first plurality of modalities comprises the spatial and temporal cerebral microvascularization parameters from which the said perfusion modalities are extracted.

15. Segmentation and/or prediction method according to one of the preceding claims, comprising differentiating between at least three categories of hypoxic region.
